(19) United States
(12) Patent Application Publication
(10) Pub. No.: US 2023/0019672 A1
(43) Pub. Date: Jan. 19, 2023

(54) HOOK CONNECTOR ARRANGEMENT FOR A CONVEYOR BELT AND CONVEYOR BELT WITH SAME

(71) Applicant: ContiTech Transportbandsysteme GmbH, Hannover (DE)

(72) Inventor: Carsten Behrens, Bilshausen (DE)

(73) Assignee: ContiTech Transportbandsysteme GmbH, Hannover (DE)

(21) Appl. No.: 17/757,010

(22) PCT Filed: Oct. 26, 2020
(86) PCT No.: PCT/EP2020/080019

§ 371 Date: Jun. 7, 2022

(30) Foreign Application Priority Data
Dec. 18, 2019 (DE) 10 2019 220 007.9

(51) Int. Cl. F16G 3/04

(52) U.S. Cl. CPC F16G 3/04

(57) ABSTRACT

The present invention relates to a hook connector arrangement (1) for a conveyor belt (3) having a plurality of hook connectors (10), which are designed to hold between them an open end of the conveyor belt (3) at least by force fit, wherein the hook connectors (10) are connected to one another on the inside in a transverse direction (Y) by means of a connecting element (19). The hook connector arrangement (1) is characterized in that at least one hook connector (10) comprises on the inside a clamping element (2) which is arranged opposite the connecting element (19).

### DESCRIPTION

The present invention relates to a hook connector arrangement for a conveyor belt as claimed in the preamble of patent claim 1 and also to a conveyor belt comprising such a hook connector arrangement as claimed in patent claim 9.

In various applications, conveyor belts are used to transport in particular goods to be conveyed. Such conveyor belts may also be known as transport belts or conveyors. The goods to be conveyed are in particular loose goods, e.g. bulk products. The conveyor belts are used as endless belts closed in the movement direction, which may also be called the conveying direction or running direction.

Such conveyor belts usually consist of a flexible material, such as rubber, in which so-called tension members are embedded for transmitting the tensile forces in the movement direction. Depending on the type of the conveyor belt, these members may be steel cables or flat textile tension members.

Usually, so-called hook connectors are used for the mechanical endless joining of conveyor belts with flat textile tension members. The hook connectors are U-shaped metallic clamps which are placed with their respective openings on an open end of the conveyor belt along the running direction of the conveyor belt, and then pressed together perpendicularly to the flat extent of the conveyor belt. This generates a force-fit connection of the hook connectors at the open end of the conveyor belt.

Usually, an additional form-fit connection of the hook connectors at the open end of the conveyor belt is achieved by additional mechanical anchoring of the hook connectors, in that individual rivet pins or screws are knocked or screwed through the fabric of the tension member and fix the top side and underside of the hook connector to the belt surface, encasing the belt end. The additional pressing force of the rivet pins or the pretension force of the screw connection may create an additional fixing of the hook connectors at the open end of the conveyor belt. The effect of the form-fit connection is here usually greater than the effect of the force-fit connection.

The hook connectors of each of the two open ends of the conveyor belt, i.e. the two belt ends, hereby form a continuous cavity in the transverse direction, i.e. transversely to the running direction and transversely to the height. At the same time, the hook connectors are narrower in the region of their U-shaped bends than in the region of the rivet connection, so that the U-shaped bends of two hook connector arrangements of corresponding open belt ends can be arranged alternately between one another in the transverse direction, and hence the two connector arrangements overlap in the transverse direction. The two open belt ends can now be connected together in an articulated manner in that a usually cylindrical connector peg is inserted in the transverse direction through the overlapping cavities of the two hook connector arrangements and secured against slipping out. Alternatively, the use of cable-like flexible connectors is also known.

In principle, such a connection can be regarded as a succession of individual hinge elements. Here, the bending ability of such a conveyor belt connected with hooks improves with the number of connector segments used over the belt width.

The disadvantage with such connections for mechanical endless joining of conveyor belts with flat textile tension members is that a static or dynamic failure of the connection can occur, which may lead to a separation of the open ends and hence to a tearing of the conveyor belt. This may lead to failure and stoppage for the corresponding conveyor belt system.

The dynamic failure of the connection usually follows the same process. Firstly, the pretension on the clamped belt surface is reduced by creep of the elastomer material, usually rubber, surrounding the flat textile tension member. Then the individual press/rivet pins become “unmeshed” from the flat textile tension member. Here, either the pin pulls the weft thread, introduced transversely to the movement direction as resistance and reinforcement, out of the textile and rubber matrix, or individual weft or warp threads begin to tear over time because of uneven loading, and weaken the connection initially only locally. In further operation of the conveyor belt, the accumulation of several such incidences of minor damage in the warp direction causes the forced breakage of the remaining warp threads or the unmeshing of the remaining weft threads under the corresponding overload for the remaining cross-section of the tension member.

It should be noted here that hook connectors or a hook connector arrangement are considerably inferior to both hot and cold vulcanization with respect to their static and dynamic connection strength. This circumstance is usually taken into account by correspondingly higher safety factors in the belt design of conveyor belts. Accordingly, a hook connector arrangement is technically inferior to “conventional” vulcanization.

Also, in the belt design, when a hook connector arrangement is used, the design of the tension member fabric, in particular with respect to interlacing of the warp threads, is of decisive importance for the belt structure. This applies in particular if a high dynamic connection strength is desired.

One object of the present invention is to provide a hook connector arrangement for a conveyor belt of the type described initially which has a higher static and/or dynamic connection strength than previously known hook connector arrangements for conveyor belts. The aim is to achieve this in the simplest, most flexible and/or cost-effective manner possible. At least, an alternative to known hook connector arrangements for conveyor belts is to be provided.

According to the invention, the object is achieved by a hook connector arrangement having the features given in claim 1 and also by a conveyor belt having the features given in claim 9. Advantageous developments are described in the dependent claims.

Thus the present invention relates to a hook connector arrangement for a conveyor belt having a plurality of hook connectors, which are designed to hold between them an open end of the conveyor belt at least by force fit, wherein the hook connectors are connected to one another on the inside in a transverse direction by means of a connecting element.

The hook connector arrangement according to the invention is characterized in that at least one hook connector comprises on the inside a clamping element which is arranged opposite the connecting element. Thus according to the invention, a clamping effect and hence force-fit connection can be exerted on the open end of the conveyor belt, whereby the force-fit connection is reinforced and in some cases an additional form-fit connection may be implemented. This may improve the mechanical attachment of the hook connector arrangement on the open end of the conveyor belt, and hence the static and/or dynamic connection strength, whereby the service life of the connection of the open ends of the conveyor belt can be extended.

An extended service life of the connection of the open ends of the conveyor belt may reduce unplanned stoppages of the corresponding conveyor belt system during operation owing to any repositioning or failure of the connection in the field. This may mean an increased availability of the conveyor belt system.

Also, manufacturing costs may be reduced in that the previously used safety factors for hook connections can be brought closer to the safety factors of a vulcanization, since then the belt strength can be reduced while still retaining the safety factors.

Furthermore, a greater and possibly also more favourable choice of technical structures for tension members for conveyor belts may be used, since additional tension members may be used and/or an improved force flow directly into the tension members can be implemented.

In other words, according to the invention, because of the concentration of the compression force on at least two local and preferably linear elements transversely to the running direction, the use of at least one additional clamping element may lead to a stronger clamping effect than with the previously known, single, smooth surface pressure. The clamping on both sides according to the invention may thus be maintained for a longer period even when the compression loading begins to reduce due to a material creep of the elastomer of the conveyor belt. This can improve the force-fit connection in comparison with known hook connector arrangements.

Furthermore, according to the invention, by the use of at least one additional clamping element, the force-fit connection, previously comprising rather a superficial pressure, of the hook connector may be supplemented by or converted into a form-fit connection, which can be created between the encasing hook connector and the conveyor belt transversely to the tensile loading of the running direction. In other words, a part of the elastomer of the conveyor belt can deform both around the connecting element and also around the clamping element, and thus lead to an additional form-fit connection of the elastomer, covering the tension member, of the conveyor belt or its cover plate.

When a flat textile tension member of the conveyor belt and rivets in the hook connector arrangement are used, by means of this additional form-fit connection, the warp thread can also be directly included in the force flow by the adhesion forces of the elastomer of the conveyor belt outside the system of weft thread and rivet pin. The dynamic load of the textile elastomer matrix present at the rivet may be reduced and hence the connection strength increased by the additional load-bearing components of the hook connector arrangement.

This may be achieved in a particularly simple, flexible and/or cost-effective manner by the use of a clamping element arranged opposite the connecting element.

According to one aspect of the invention, the hook connectors each comprise on the inside a clamping element which is arranged opposite the connecting element. This can be implemented by means of a common continuous clamping element or by at least one respective individual clamping element. In each case, the properties and advantages described above may be implemented and used in several and possibly all hook connectors of the hook connector arrangement.

According to a further aspect of the invention, the hook connectors comprise on the inside a common clamping element which is arranged opposite the connecting element and extends over the hook connectors in the transverse direction. Thus the properties and advantages described above may be implemented and used in several and possibly all hook connectors of the hook connector arrangement. This may be achieved comparatively easily with a common clamping element. Secondly, at the same time, the hook connection may also be connected on the side of the hook connector lying opposite the connecting element in the transverse direction, which may improve the durability of the connection. Also, the positioning of the hook connectors relative to one another, or the mutual connection of the hook connectors may be improved.

According to a further aspect of the invention, the connecting element and the clamping element are arranged directly opposite one another. This may further reinforce the above-described effects of the clamping element.

According to a further aspect of the invention, the connecting element is configured as a connecting wire extending in the transverse direction. This may simplify implementation since only one connecting element need be used. This can be achieved in particular comparatively simply and/or cost-effectively as a wire.

According to a further aspect of the invention, the clamping element is configured as a clamping wire extending in the transverse direction. This may simplify implementation since only one clamping element need be used. This can be achieved in particular comparatively simply and/or cost-effectively as a wire.

According to a further aspect of the invention, the clamping element is configured to penetrate into the conveyor belt, preferably into an elastomer cover layer of the conveyor belt. This may be achieved for example by a rough surface of the clamping element, by protrusions and similar arranged on the surface of the clamping element. The latter may for example be achieved by points and such like. In each case, the penetration of the clamping element into the conveyor belt may achieve an additional form-fit attachment between the clamping element and hence the hook connectors and the conveyor belt, whereby the static and/or dynamic connection strength may be further increased.

According to a further aspect of the invention, the hook connectors are furthermore configured to hold between them the open end of the conveyor belt by form fit as well as by means of rivets. This may further increase the static and/or dynamic connection strength.

The present invention also relates to a conveyor belt with at least one hook connector arrangement as described above. In this way, the above-described properties and advantages of a hook connector arrangement according to the invention may be implemented and used in a conveyor belt.

According to one aspect of the invention, the conveyor belt comprises a flat textile tension member. In this way, the hook connector arrangement according to the invention may be used with such conveyor belts, which may lead to the properties and advantages described initially. Such flat textile tension members are in particular woven fabrics which can effectively transmit tensile forces in the running direction of the conveyor belt.

According to a further aspect of the invention, the conveyor belt comprises a plurality of cable-like tension members which extend parallel to one another in a running direction of the conveyor belt. In this way, the hook connector arrangement according to the invention may be used with such conveyor belts, which may lead to the properties and advantages described initially. Such cable-like tension members are in particular steel cables which can effectively transmit tensile forces in the running direction of the conveyor belt.

According to a further aspect of the invention, the conveyor belt comprises a respective elastomer cover layer which has a greater Shore hardness than an elastomer base body arranged between the two elastomer cover layers. This may promote the force-fit and/or form-fit effect of the hook connector arrangement according to the invention.

An exemplary embodiment and further advantages of the invention will be discussed below in connection with the following figures. In the drawings:

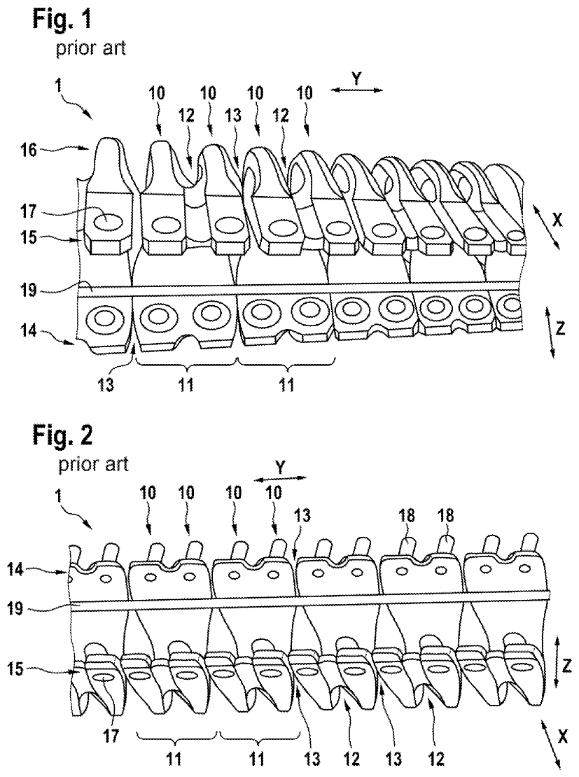

FIG. 1 shows a perspective schematic illustration of a known hook connector arrangement;

FIG. 2 shows a further perspective schematic illustration of the known hook connector arrangement from FIG. 1;

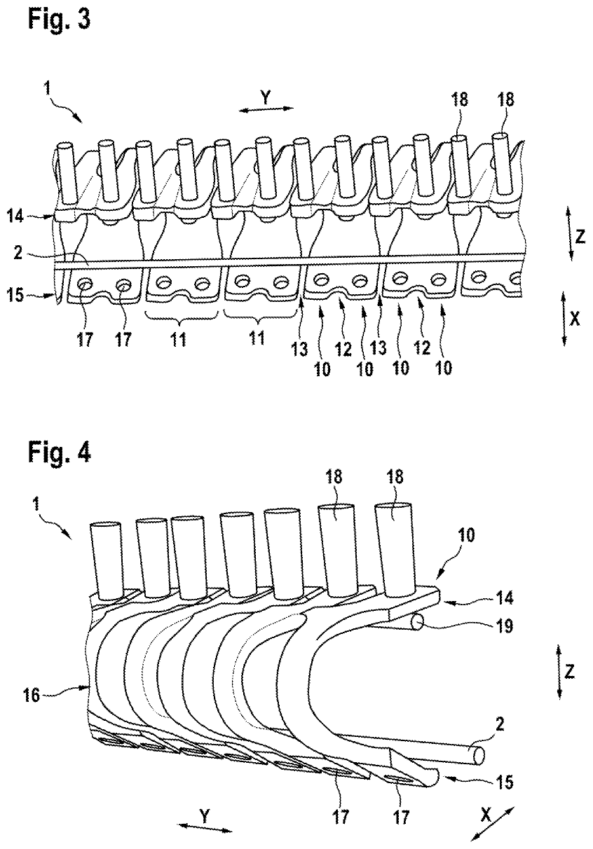

FIG. 3 shows a perspective schematic illustration of a hook connector arrangement according to the invention;

FIG. 4 shows a further perspective schematic illustration of the hook connector arrangement according to the invention from FIG. 3; and

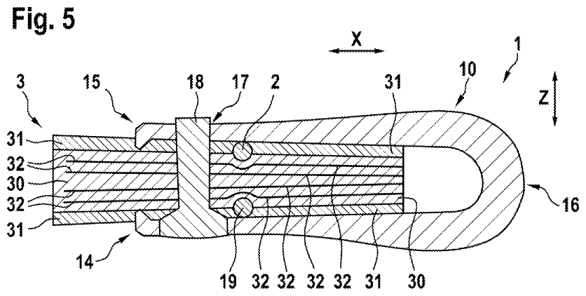

FIG. 5 shows a schematic cross-section through the hook connector arrangement according to the invention at an open end of a conveyor belt.

The description of the abovementioned figures is given in Cartesian coordinates with a longitudinal direction X, a transverse direction Y oriented perpendicularly to the longitudinal direction X, and a vertical direction Z oriented perpendicularly both to the longitudinal direction X and also to the transverse direction Y. The longitudinal direction X may also be referred to as the depth X or running direction X of the conveyor belt 3, the transverse direction Y as the width Y, and the vertical direction Z as the height Z.

FIG. 1 shows a perspective schematic illustration of a known hook connector arrangement 1. FIG. 2 shows a further perspective schematic illustration of the known hook connector arrangement 1 from FIG. 1.

The known hook connector arrangement 1 from FIGS. 1 and 2 has a plurality of structurally identical hook connector pairs 11, each of which comprises two structurally identical hook connectors 10. The two hook connectors 10 of a hook connector pair 11 are connected together by substance bonding in the width Y at two connection points 12. The individual hook connector pairs 11 are spaced apart from one another by distances 13 in the width Y.

Each hook connector 10 has an open end 14 on the rivet head side and an open end 15 on the rivet foot side, which are connected by a U-shaped bend 16. At the open end 14 on the rivet head side, a rivet 18 is provided in each case which passes through a passage opening 17, opposite this in the height Z, of the open ends 15 on the rivet foot side of the hook connectors 10, and can then be deformed from the outside.

The individual hook connector pairs 11 are connected together in the width Y by a connecting element 19 in the form of a connecting wire 19, which is arranged by substance bonding on the inside at the open end 14 on the rivet head side of the hook connectors 10. Thereby the known hook connector arrangement 1 is formed.

FIG. 3 shows a perspective schematic illustration of a hook connector arrangement 1 according to the invention. FIG. 4 shows a further perspective schematic illustration of the hook connector arrangement 1 according to the invention from FIG. 3. FIG. 5 shows a schematic cross-section through the hook connector arrangement 1 according to the invention at an open end of a conveyor belt 3.

The hook connector arrangement 1 according to the invention, in FIGS. 3 to 5, differs from the known hook connector arrangement from FIGS. 1 and 2 in that, in the hook connector arrangement 1 according to the invention in FIGS. 3 to 5, running parallel to the connecting wire 19, a clamping element 2 in the form of a clamping wire 2 is arranged by substance bonding on the inside at the open ends 15 on the rivet foot side of the hook connectors 10.

If now a hook connector arrangement 1 according to the invention is arranged at an open end of the above-mentioned conveyor belt 3, and its two open ends 14, 15 are there pressed together in the height Z and riveted (see FIG. 5), the connecting wire 19 and the additional clamping wire 2 press from both sides in the height Z onto the elastomer cover layers 31 of the conveyor belt 3. Thus the elastomer base body 30 of the conveyor belt 3, with the flat textile tension members 32 embedded therein, is also compressed in the height Z.

In this way, in addition to the force-fit connection previously created by the known hook connector arrangement 1 between the open ends 14, 15, both an increased force-fit connection and an additional form-fit connection are created between the connecting wire 19 and the clamping wire 2, independently of the action of the rivets 18. This may improve both the static and the dynamic connection strength and hence extend the service life of the connection of the open ends of the conveyor belt 3.

### LIST OF REFERENCES SIGNS (PART OF THE DESCRIPTION)

X Longitudinal direction; depth; running direction
Y Transverse direction; width
Z Vertical direction; height
1 Hook connector arrangement
10 Hook connector
11 Hook connector pairs
12 Connecting points of hook connectors 10 of a hook connector pair 11
13 Distances between hook connectors 10 of a hook connector pair 11
14 Open ends on rivet head side of hook connectors 10
15 Open ends on rivet foot side of hook connectors 10
16 U-shaped bends of hook connectors 10
17 Passage openings of open ends 14 on rivet foot side of hook connectors 10
18 Rivets of open ends 15 on rivet foot side of hook connectors 10
19 Connecting element or connecting wire of hook connector pairs 11
2 Clamping element; clamping wire
3 Conveyor belt
30 Elastomer main body
31 Elastomer cover layers
32 Flat textile tension member; cable-like tension member

1.-12. (canceled)

13. A hook connector arrangement for a conveyor belt comprising a plurality of hook connectors, which are designed to hold between them an open end of the conveyor belt at least by force fit;
wherein the hook connectors are connected to one another on the inside in a transverse direction (Y) by means of a connecting element;
wherein at least one hook connector comprises on the inside a clamping element which is arranged opposite the connecting element; and,
wherein the conveyor belt comprises an elastomer.

14. The hook connector arrangement as claimed in claim 13, wherein the hook connectors each comprise on the inside a clamping element which is arranged opposite the connecting element.

15. The hook connector arrangement as claimed in claim 13, wherein the hook connectors comprise on the inside a common clamping element which is arranged opposite the connecting element and extends over the hook connectors in the transverse direction (Y).

16. The hook connector arrangement as claimed in claim 13, wherein the connecting element and the clamping element are arranged directly opposite one another.

17. The hook connector arrangement as claimed in claim 13, wherein the connecting element is configured as a connecting wire extending in the transverse direction (Y).

18. The hook connector arrangement as claimed in claim 13, wherein the clamping element is configured as a clamping wire extending in the transverse direction (Y).

19. The hook connector arrangement as claimed in claim 13, wherein the clamping element is configured to penetrate into the conveyor belt.

20. The hook connector arrangement as claimed in claim 13, wherein the clamping element is configured to penetrate into an elastomer cover layer of the conveyor belt.

21. The hook connector arrangement as claimed in claim 13, wherein the hook connectors are furthermore configured to hold the open end of the conveyor belt between them by form fit as well as by rivets.

22. The hook connector arrangement as claimed in claim 13, wherein the hook connectors are furthermore configured to hold the open end of the conveyor belt between them by form fit as well as by screws.

23. The hook connector arrangement as claimed in claim 13, wherein a part of the elastomer of the conveyor belt deforms around the connecting element and around the clamping element.

24. The hook connector arrangement as claimed in claim 23, wherein an additional form-fit connection of the elastomer, covering a tension member, of the conveyor belt is provided.

25. The hook connector arrangement as claimed in claim 23, wherein an additional form-fit connection of the elastomer, covering a tension member, of the conveyor belt cover plate is provided.

26. The hook connector arrangement as claimed in claim 13, wherein the clamping element is configured to penetrate into an elastomer cover layer of the conveyor belt, and wherein the clamping element comprises a rough surface.

27. The hook connector arrangement as claimed in claim 13, wherein the clamping element is configured to penetrate into an elastomer cover layer of the conveyor belt, and wherein the clamping element comprises protrusions.

28. The hook connector arrangement as claimed in claim 27, wherein the protrusions are points.

29. The hook connector arrangement as claimed in claim 13 comprised in conveyor belt.

30. The hook connector arrangement as claimed in claim 29, wherein the conveyor belt comprises a flat textile tension member.

31. The hook connector arrangement as claimed in claim 29, wherein the conveyor belt comprises a plurality of cable-like tension members (32) which extend parallel to one another in a running direction (X) of the conveyor belt.

32. The hook connector arrangement as claimed in claim 29, wherein the conveyor belt comprises opposing elastomer cover layers which has a greater Shore hardness than an elastomer base body arranged between the opposing elastomer cover layers.
